(19) United States
(12) Patent Application Publication
(10) Pub. No.: US 2026/0019708 A1
(43) Pub. Date: Jan. 15, 2026

(54) THREE-DIMENSIONAL INFORMATION PROCESSING DEVICE AND THREE-DIMENSIONAL INFORMATION PROCESSING METHOD

(71) Applicant: JVCKENWOOD Corporation, Kanagawa (JP)

(72) Inventor: Atsushi SUZUKI, Kanagawa (JP)

(21) Appl. No.: 19/327,775

(22) Filed: Sep. 12, 2025

Related U.S. Application Data
(63) Continuation of application No. PCT/JP2024/005217, filed on Feb. 15, 2024.

(30) Foreign Application Priority Data
Mar. 22, 2023 (JP) 2023-045659

(51) Int. Cl. H04N 23/69; G01S 17/894

(52) U.S. Cl. CPC H04N 23/69; G01S 17/894

(57) ABSTRACT

A three-dimensional information processing device includes a first acquisition unit configured to acquire first point group data which is point group data of a subject acquired at a first zoom magnification by a first point group data acquisition device, a second acquisition unit configured to acquire second point group data which is point group data of the subject acquired at a second zoom magnification by a second point group data acquisition device, the second point group data acquisition device acquiring point group data at an angle of view of which at least a part overlaps an angle of view at which the first point group data acquisition device acquires the first point group data, and an identification unit configured to identify overlapping portions of point groups included in the first point group data and point groups included in the second point group data.

### CROSS REFERENCE TO RELATED APPLICATION

This application is a bypass continuation of PCT/JP2024/005217 filed Feb. 15, 2024, from which priority is claimed on Japanese Patent Application No. 2023-045659, filed Mar. 22, 2023, the content of which is incorporated herein by reference.

### BACKGROUND OF THE INVENTION

### Technical Field

The present invention relates to a three-dimensional information processing device and a three-dimensional information processing method.

### Background Art

In the related art, acquisition of three-dimensional information of a subject from a plurality of viewpoints using a plurality of range-finding cameras has been carried out. The pieces of three-dimensional information acquired by the plurality of range-finding cameras are combined into one piece of three-dimensional information. By acquiring three-dimensional information of a subject from a plurality of viewpoints using a plurality of range-finding cameras, three-dimensional information with higher reproducibility can be acquired in comparison with a case in which three-dimensional information is acquired in one direction using one range-finding camera. For example, a technique described in Patent Document 1 can be used as the technique of combining three-dimensional information acquired from a plurality of range-finding cameras into one piece of three-dimensional information.

### CITATION LIST

### Patent Document

Patent Document 1: Japanese Unexamined Patent Application, First Publication No. H7-174538

### SUMMARY OF INVENTION

Here, optical enlargement and reduction can be realized without changing an imaging position of a camera by applying a zoom lens in a range-finding camera. When a zoom lens is applied in each of a plurality of range-finding cameras, a reduction/enlargement magnification may vary depending on the range-finding cameras due to mechanical unevenness, a control error, or the like of the zoom lenses. When three-dimensional information acquired from a plurality of range-finding cameras with uneven reduction/enlargement magnifications is combined into a single piece of three-dimensional information, joining portions are mismatched, and thus it is necessary to digitally perform a reduction process or an enlargement process. There is a likelihood of damage in quality of three-dimensional information as a whole due to such a reduction process or an enlargement process. For example, when two pieces of three-dimensional information are joined after an enlargement process is digitally performed on one piece at the time of combination of the two pieces of three-dimensional information, there is a problem in that a resolution of the piece of three-dimensional information on which the enlargement process has been performed may become lower than that of the piece of three-dimensional information on which the enlargement process has not been performed and wholly unbalanced three-dimensional information may be acquired.

The present invention was made in consideration of the aforementioned circumstances, and an objective thereof is to provide a three-dimensional information processing device and a three-dimensional information processing method that can appropriately combine three-dimensional information acquired using a plurality of range-finding cameras.

[1] An aspect of an embodiment is a three-dimensional information processing device including a first acquisition unit configured to acquire first point group data which is point group data of a subject acquired at a first zoom magnification by a first point group data acquisition device, a second acquisition unit configured to acquire second point group data which is point group data of the subject acquired at a second zoom magnification by a second point group data acquisition device, the second point group data acquisition device acquiring point group data at an angle of view of which at least a part overlaps an angle of view at which the first point group data acquisition device acquires the first point group data, an identification unit configured to identify overlapping portions of point groups included in the first point group data and point groups included in the second point group data, a calculation unit configured to calculate a reduction/enlargement magnification of the second point group data with respect to the first point group data when the identified overlapping portions are compared, and a determination unit configured to determine whether the calculated reduction/enlargement magnification is less than a predetermined threshold value.

[2] Another aspect of the embodiment is the three-dimensional information processing device according to the aspect of [1], further including a zoom magnification control unit configured to output a control signal for controlling the zoom magnification of the second point group data acquisition device when the determination unit determines that the calculated reduction/enlargement magnification is greater than the predetermined threshold value.

[3] Another aspect of the embodiment is the three-dimensional information processing device according to the aspect of [3], wherein the zoom magnification control unit acquires the zoom magnification of the first point group data acquisition device acquiring the first point group data and outputs the control signal for controlling the zoom magnification of the second point group data acquisition device according to the acquired zoom magnification.

[4] Another aspect of the embodiment is the three-dimensional information processing device according to the aspect of any one of [1] to [3], further including a third acquisition unit configured to acquire third point group data which is point group data of the subject acquired at a third zoom magnification by a third point group data acquisition device, the third point group data acquisition device acquiring point group data at an angle of view of which at least a part overlaps an angle of view at which the first point group data acquisition device acquires the first point group data and a fourth acquisition unit configured to acquire fourth point group data from a fourth point group data acquisition device, the fourth point group data acquisition device acquiring point group data at an angle of view not overlapping an angle of view at which the first point group data acquisition device acquires the first point group data, wherein the identification unit identifies overlapping portions of point groups included in the fourth point group data and point groups included in the second point group data and identifies overlapping portions of point groups included in the fourth point group data and point groups included in the third point group data, the calculation unit calculates a reduction/enlargement magnification of the second point group data with respect to the fourth point group data when the identified overlapping portions are compared and a reduction/enlargement magnification of the third point group data with respect to the fourth point group data when the identified overlapping portions are compared, and the zoom magnification control unit outputs a control signal for controlling a zoom magnification of the fourth point group data acquisition device on the basis of the reduction/enlargement magnification of the second point group data with respect to the fourth point group data and the reduction/enlargement magnification of the third point group data with respect to the fourth point group data.

[5] Another aspect of the embodiment is a three-dimensional information processing method including a first acquisition step of acquiring first point group data which is point group data of a subject acquired at a first zoom magnification by a first point group data acquisition device, a second acquisition step of acquiring second point group data which is point group data of the subject acquired at a second zoom magnification by a second point group data acquisition device, an identification step of identifying overlapping portions of point groups included in the first point group data and point groups included in the second point group data, a calculation step of calculating a reduction/enlargement magnification of the second point group data with respect to the first point group data when the identified overlapping portions are compared, and a determination step of determining whether the calculated reduction/enlargement magnification is less than a predetermined threshold value.

According to the embodiment, it is possible to appropriately combine three-dimensional information acquired using a plurality of range-finding cameras.

### BRIEF DESCRIPTION OF DRAWINGS

FIG. 1 A functional configuration diagram illustrating an example of a functional configuration of a three-dimensional information acquisition system according to an embodiment.

FIG. 2 A diagram illustrating ranges of point group data acquired by a plurality of cameras provided in the three-dimensional information acquisition system according to the embodiment.

FIG. 3 A diagram schematically illustrating steps of a three-dimensional information processing method according to the embodiment.

FIG. 4 A first diagram illustrating a combined point group of point group data acquired by the plurality of cameras provided in the three-dimensional information acquisition system according to the embodiment.

FIG. 5 A second diagram illustrating the combined point group of point group data acquired by the plurality of cameras provided in the three-dimensional information acquisition system according to the embodiment.

FIG. 6 A functional configuration diagram illustrating an example of a functional configuration of a three-dimensional information processing device according to the embodiment.

FIG. 7 A flowchart illustrating a process flow of the three-dimensional information processing method according to the embodiment.

FIG. 8 A block diagram illustrating an example of an internal configuration of the three-dimensional information processing device according to the embodiment.

### DETAILED DESCRIPTION OF THE INVENTION

An exemplary embodiment of a three-dimensional information processing device and a three-dimensional information processing method according to an aspect of the present invention will be described below in detail with reference to the accompanying drawings. The following embodiment is only an example, and embodiments of the present invention are not limited to the following embodiment. “On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information). In the drawings used for the following description, scales, numbers, and the like of structures may be made to be different from actual scales, numbers, and the like of the structures in order to make the structures be easily recognized.

### EMBODIMENT

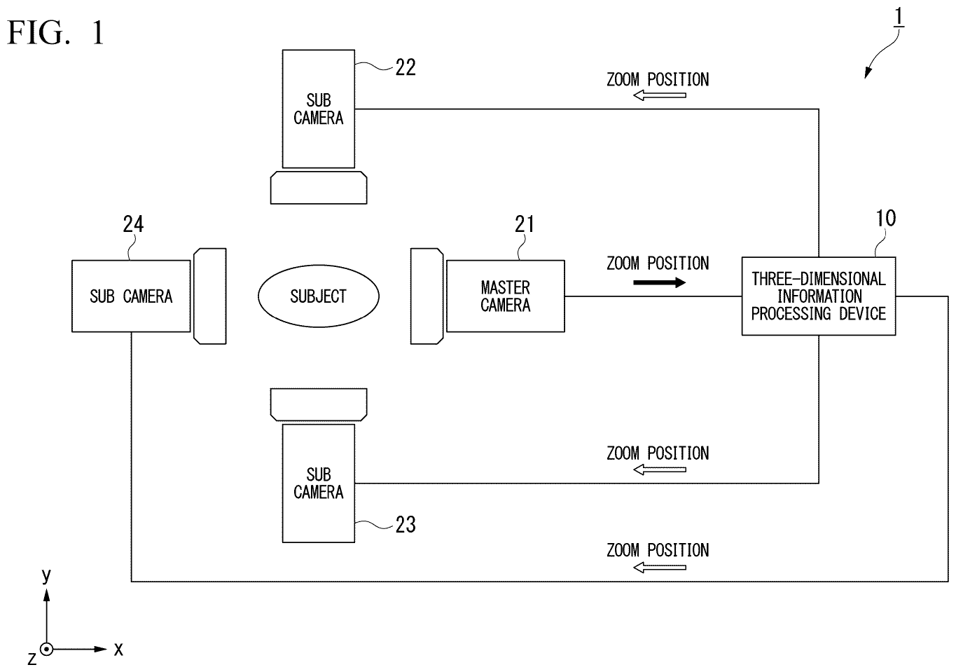

FIG. 1 is a functional configuration diagram illustrating an example of a functional configuration of a three-dimensional information acquisition system according to an embodiment. An example of a functional configuration of a three-dimensional information acquisition system 1 will be described with reference to the drawing. In the following description, an imaging angle of a camera or the like may be described on the basis of a three-dimensional orthogonal coordinate system of an x axis, a y axis, and a z axis. The x axis, the y axis, and the z axis illustrated in the drawing are not axes of a coordinate system seen from a camera, but are three-dimensional axes for indicating relative directions in the drawings.

The three-dimensional information acquisition system 1 includes a three-dimensional information processing device 10, one master camera 21, and one or more sub cameras. In the illustrated example, a sub camera 22, a sub camera 23, and a sub camera 24 are illustrated as an example of one or more sub cameras. In the following description, the master camera 21 may be referred to as a first point group data acquisition device, the sub camera 22 may be referred to as a second point group data acquisition device, the sub camera 23 may be referred to as a third point group data acquisition device, and the sub camera 24 may be referred to as a fourth point group data acquisition device. In the following description, a plurality of sub cameras included in the three-dimensional information acquisition system 1 may be simply referred to as a sub camera when they are not distinguished from each other.

In the present embodiment, the number of sub cameras included in the three-dimensional information acquisition system 1 may be arbitrary. It is possible to more accurately acquire three-dimensional information of a subject as a whole by increasing the number of sub cameras and acquiring three-dimensional information of a subject at various angles.

All of the master camera 21 and the sub cameras are range-finding cameras. In the following description, the master camera 21 and the sub cameras may be referred to as range-finding cameras when they are not distinguished from each other. The range-finding camera according to the present embodiment acquires three-dimensional information of a subject by two-dimensionally measuring a distance to a subject to correspond to an image (or a video) to be captured. The three-dimensional information of a subject acquired by the range-finding camera may be, for example, three-dimensional point group data. The range-finding camera may two-dimensionally radiate light to a subject and measure the distance on the basis of the time to reception of reflected light, for example, using a time of flight (ToF) method.

Here, it is preferable that angles of view of neighboring range-finding cameras overlap at least partially. For example, it is preferable that the angle of view of the master camera 21 and the angle of view of the sub camera 22 overlap at least partially, the angle of view of the sub camera 22 and the angle of view of the sub camera 24 overlap at least partially, the angle of view of the sub camera 24 and the angle of view of the sub camera 23 overlap at least partially, and the angle of view of the sub camera 23 and the angle of view of the master camera 21 overlap at least partially. Since the range-finding cameras have ranges which overlap at least partially, the pieces of three-dimensional information acquired by the range-finding cameras can be combined by the three-dimensional information processing device 10. The angles of view of the range-finding cameras not adjacent to each other such as the master camera 21 and the sub camera 24 do not have to overlap each other.

In the illustrated example, it is assumed that a three-dimensional shape in an x-y plane of a subject be acquired comprehensively for the purpose of simplification of description. In other words, in the illustrated example, angles of view of each range-finding camera and a range-finding camera adjacent thereto overlap partially at least in the x-y plane. However, the present embodiment is not limited to this example, and it is preferable that a three-dimensional shape of a subject be acquired in three dimensions including the z-axis direction. For example, the three-dimensional information acquisition system 1 may include a fourth sub camera (not illustrated) having an angle of view of which at least a part in the x-z plane overlap the angle of view of the master camera 21. The three-dimensional information acquisition system 1 further includes the fourth sub camera and thus can acquire three-dimensional information when a subject is observed in the z-axis direction.

Each range-finding camera includes a zoom lens, and a reduction/enlargement magnification thereof can be changed. In the following description, the reduction/enlargement magnification which is set by a mechanism provided in the zoom lens may be referred to as a zoom position, a zoom magnification, or the like. The zoom position of the master camera 21 is set, for example, on the basis of an operator's operation. The master camera 21 outputs information on the zoom position set on the basis of an operator's operation to the three-dimensional information processing device 10. The three-dimensional information processing device 10 acquires information on the zoom position from the master camera 21, calculates zoom positions of the sub cameras on the basis of the acquired information on the zoom position, and outputs information on the calculated zoom positions to the sub cameras. The three-dimensional information processing device 10 may apply the zoom position of the master camera 21 as the zoom positions of the sub cameras without any change.

Here, the three-dimensional information processing device 10 performs adjustment of the zoom position on each sub camera two times. The first adjustment is coarse adjustment based on the zoom position acquired from the master camera 21. Each range-finding camera acquires three-dimensional information of a subject in a state in which coarse adjustment has been performed and outputs the acquired information to the three-dimensional information processing device 10. The three-dimensional information processing device 10 acquires three-dimensional information from the range-finding cameras and performs the second adjustment of the zoom position on the basis of the acquired three-dimensional information. That is, the second adjustment of the zoom position can be said to be minute adjustment in comparison with the first coarse adjustment. Each range-finding camera acquires three-dimensional information of a subject in a state in which minute adjustment has been performed and outputs the acquired information to the three-dimensional information processing device 10. The three-dimensional information processing device 10 acquires three-dimensional information from the range-finding cameras and generates three-dimensional information of the subject by combining the acquired three-dimensional information into one piece of three-dimensional information.

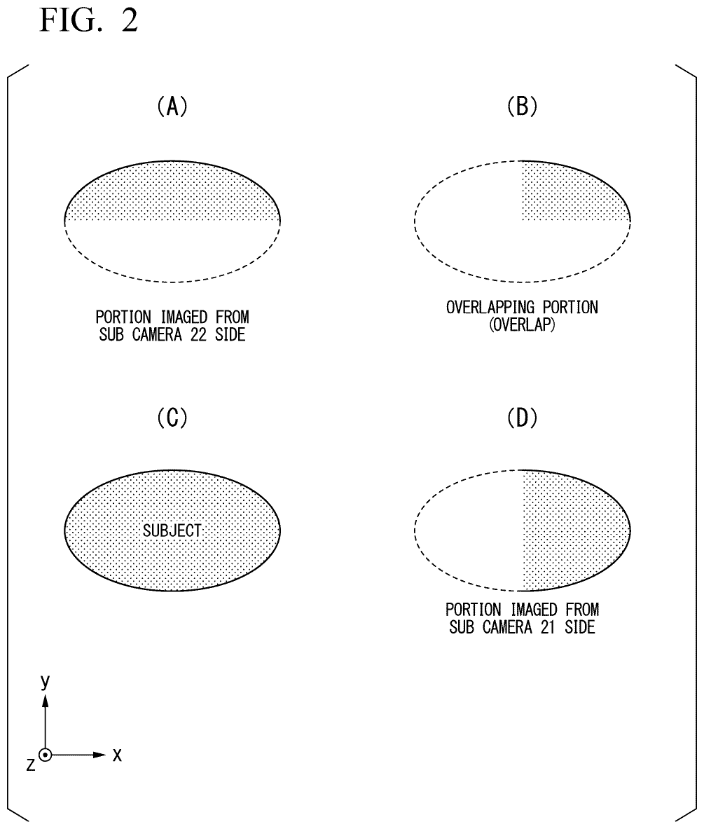

FIG. 2 is a diagram illustrating ranges of point group data which is acquired by a plurality of cameras provided in the three-dimensional information acquisition system according to the present embodiment. An example in which angles of view of neighboring range-finding cameras overlap partially will be described with reference to the drawing. A three-dimensional orthogonal coordinate system illustrated in the drawing corresponds to the coordinate system illustrated in FIG. 1.

FIG. 2(C) schematically illustrating an example of a shape of a subject in the x-y plane. In other words, FIG. 2(C) is also a plan view when a subject is seen in the z-axis direction. FIG. 2(A) illustrates a range which can be acquired when three-dimensional information of the subject is acquired from the sub camera 22 side. FIG. 2(D) illustrates a range which can be acquired when three-dimensional information of the subject is acquired from the master camera 21 side. Since the range-finding cameras according to the present embodiment acquire point group data measured, for example, using the ToF method, three-dimensional information of positions which can be irradiated with light from the range-finding cameras can be acquired.

For example, when three-dimensional information is acquired from only one range-finding camera as in the related art, only three-dimensional information of a half of a subject can be acquired as illustrated in FIG. 2(A) or 2(D). However, according to the three-dimensional information acquisition system 1, three-dimensional information of a subject at a plurality of viewpoints can be acquired at various angles. Here, FIG. 2(B) illustrates overlapping portions (overlapped portions) of the three-dimensional information acquired from the master camera 21 side and the three-dimensional information acquired from the sub camera 22 side. The angle of view of a range-finding camera and the angle of view of a camera adjacent thereto according to the present embodiment have an overlapping portion.

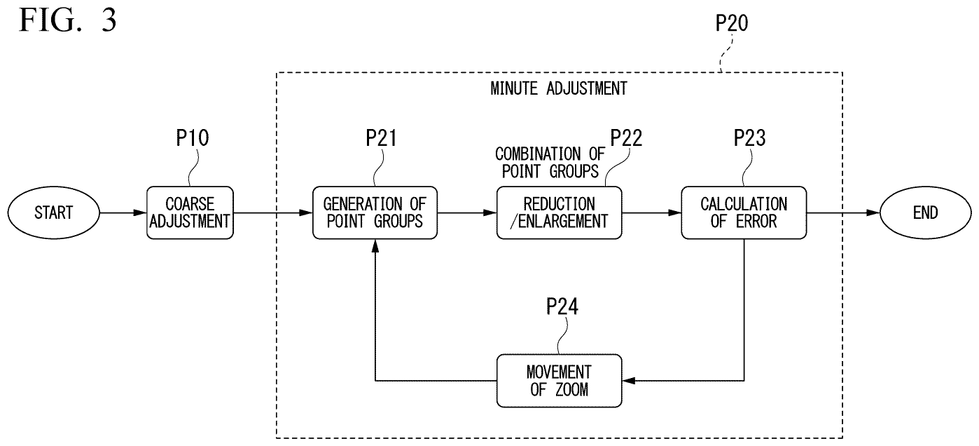

FIG. 3 is a diagram schematically illustrating steps of a three-dimensional information processing method according to the present embodiment. The steps of the three-dimensional information processing method according to the present embodiment will be described with reference to the drawing.

(Step P10) In this step, coarse adjustment of a zoom position is performed. The coarse adjustment of a zoom position is performed when the zoom position of the master camera 21 is changed by an operator's operation or the like. The three-dimensional information processing device 10 acquires the zoom position of the master camera 21 and controls the zoom positions of the sub cameras on the basis of the acquired zoom position. Controlling the zoom positions of the sub cameras on the basis of the acquired zoom position may include, for example, setting a reduction/enlargement magnification of each sub camera such that it becomes equal to the reduction/enlargement magnification of the master camera 21. Here, in adjustment of a zoom position using the coarse adjustment, the magnifications of the acquired point group data may not equal to each other due to mechanical unevenness, a control error, or the like of the zoom lenses. Therefore, the three-dimensional information acquisition system 1 accurately matches the zoom positions of the range-finding cameras by further performing minute adjustment.

(Step P20) In this step, minute adjustment of a zoom position is performed. The minute adjustment of a zoom position is adjustment of a zoom position which is performed on the basis of three-dimensional information after the three-dimensional information is acquired in a state in which the coarse adjustment of Step P10 has been performed. The minute adjustment of a zoom position specifically includes Steps P21 to P24. The steps will be described below in detail.

(Step P21) First, in a state in which the coarse adjustment of Step P10 has been performed, the three-dimensional information processing device 10 acquires point group data from the range-finding cameras.

(Step P22) Then, the three-dimensional information processing device 10 combines the point group data acquired from the neighboring range-finding cameras. Here, combination of point group data is performed by reducing or enlarging the point group data on one side with respect to the point group data on the other side. The priority order of the point group data serving as a reference may be the order of point group data acquired by the master camera 21, point group data acquired by a sub camera adjacent to the master camera 21, and point group data acquired by a sub camera adjacent to the sub camera adjacent to the master camera 21.

(Step P23) Then, the three-dimensional information processing device 10 determines whether the reduction/enlargement magnifications used for combination of point group data in Step P22 are equal to or greater than a predetermined threshold value. Here, in the minute adjustment step, since point group data acquired in a state in which coarse adjustment for matching the zoom position has been performed already is used, the point group data can be logically accurately combined even when reduction/enlargement magnification is not performed. However, the reduction/enlargement magnifications may not match actually due to mechanical unevenness, a control error, or the like of the zoom lenses. Accordingly, the reduction/enlargement magnifications used for combination of point group data in Step P22 can also be said to be an error. As a result, Step P23 can also be said to be an error calculating step.

(Step P24) When the error calculated in Step P23 is equal to or greater than the predetermined threshold value, the zoom position is additionally changed on the basis of the calculated error. When the zoom position is changed, the process flow is returned to the point group data acquiring step of Step P21, and thus minute adjustment is repeated until the error becomes less than a predetermined threshold value. When the error calculated in Step P23 becomes less than the predetermined threshold value, the three-dimensional information acquisition system 1 ends the process flow.

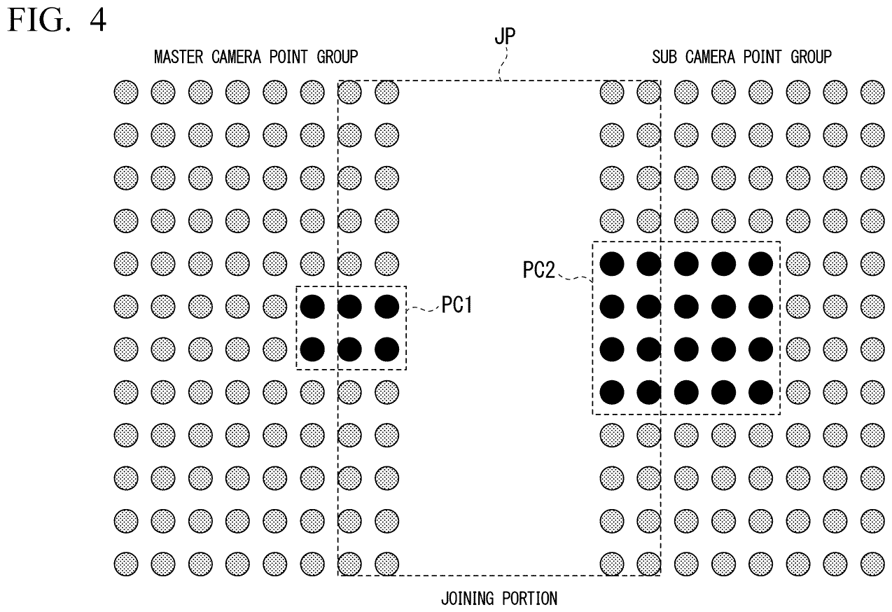

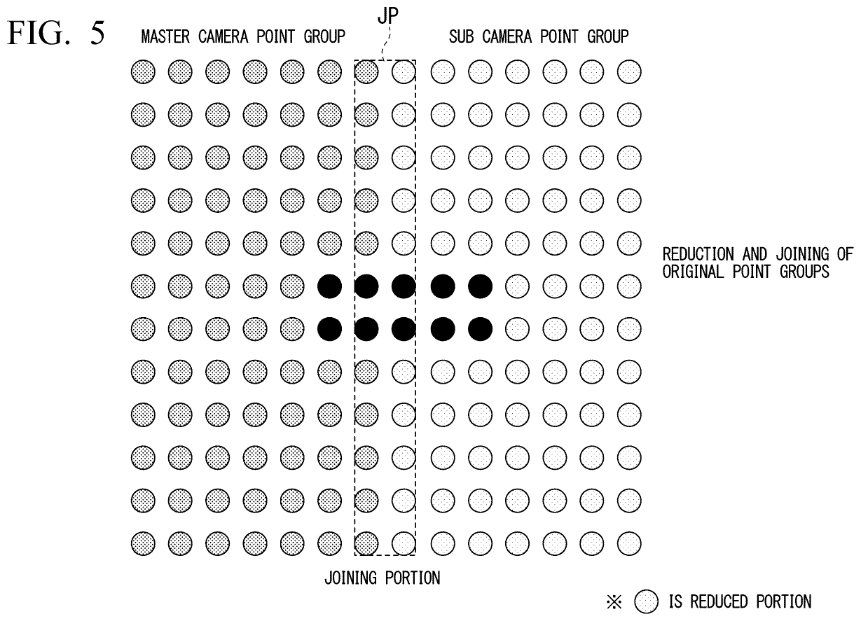

FIG. 4 is a first diagram illustrating combined point groups of point group data acquired by a plurality of cameras provided in the three-dimensional information acquisition system according to the present embodiment. FIG. 5 is a second diagram illustrating combined point groups of point group data acquired by a plurality of cameras provided in the three-dimensional information acquisition system according to the present embodiment. Combination of point group data according to the present embodiment will be described below with reference to FIGS. 4 and 5.

The left part of FIG. 4 illustrates a part of point group data acquired by the master camera 21. The right part of the drawing illustrates a part of point group data acquired by a sub camera adjacent to the master camera 21. A portion in which the point group data overlap each other is illustrated as a joining portion JP. Here, a point group PC1 and a point group PC2 are point groups obtained by imaging the same place. As can be apparently seen from the drawing, the point group PC1 and the point group PC2 have different sizes. Accordingly, when the point group data acquired by the master camera 21 and the point group data acquired by the sub camera adjacent to the master camera 21 are joined without any change, the combined point groups become unbalanced. In the illustrated example, the combined point groups are generated by reducing the point group data acquired by the sub camera adjacent to the master camera 21 with respect to the point group data acquired by the master camera 21.

FIG. 5 illustrates combined point groups which are generated by reducing point group data acquired by a sub camera adjacent to the master camera 21. By reducing the point group data acquired by a sub camera adjacent to the master camera 21, the combined point groups can be generated without causing the combined point groups to be unbalanced. However, since one side of the point groups are digitally processed and joined in this state, the resolutions of both sides do not match, and the point group data becomes unbalanced as a whole. Accordingly, according to the present embodiment, by additionally controlling the zoom positions on the basis of the reduction/enlargement magnifications used to generate the combined point groups and acquiring the point group data again, it is possible to curb the point group data from becoming unbalanced.

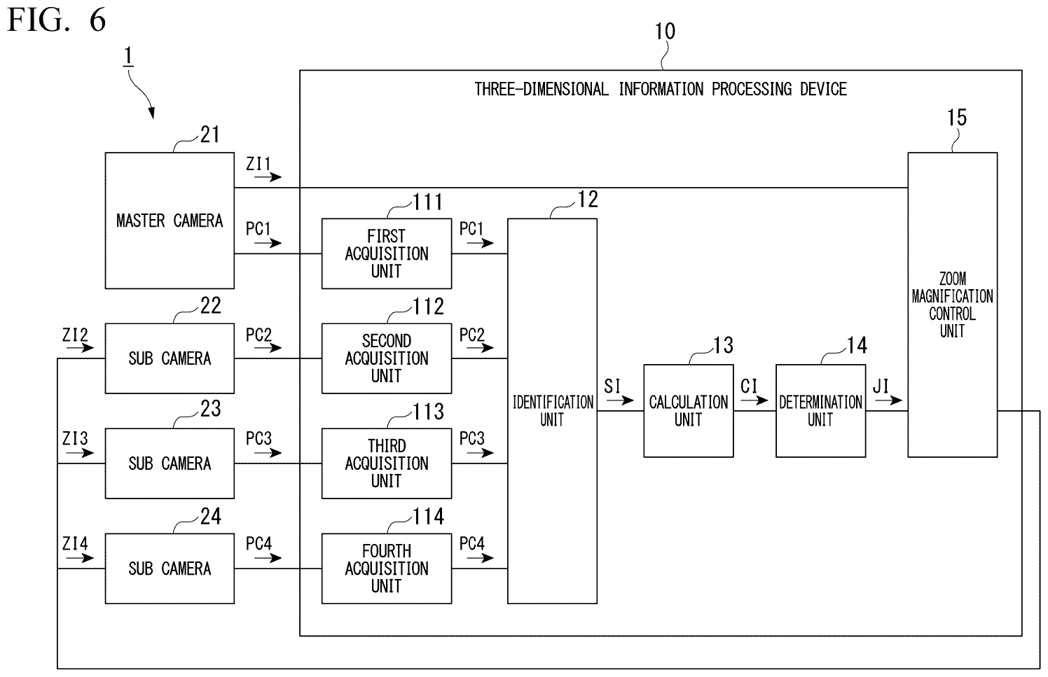

FIG. 6 is a functional configuration diagram illustrating an example of the functional configuration of the three-dimensional information processing device according to the present embodiment. An example of the functional configuration of the three-dimensional information processing device 10 will be described below with reference to the drawing. The drawing illustrates an example in which one master camera 21 and three sub cameras are used. However, the present embodiment is not limited to the example, and the number of sub cameras can be arbitrarily increased or decreased.

The three-dimensional information processing device 10 includes, a first acquisition unit 111, a second acquisition unit 112, a third acquisition unit 113, a fourth acquisition unit 114, an identification unit 12, a calculation unit 13, a determination unit 14, and a zoom magnification control unit 15. These functional units are realized, for example, using electronic circuits. Each functional unit may include a storage means such as a semiconductor memory or a magnetic hard disk device therein according to necessity. The functions may be realized by a computer and software.

The first acquisition unit 111 acquires first point group data PC1 from the master camera 21. The first point group data PC1 is point group data of a subject which is acquired at a first zoom magnification by the master camera 21. The first acquisition unit 111 provides the acquired first point group data PC1 to the identification unit 12. The second acquisition unit 112 acquires second point group data PC2 from the sub camera 22. The second point group data PC2 is point group data of a subject which is acquired at a second zoom magnification by the sub camera 22. The second acquisition unit 112 provides the acquired second point group data PC2 to the identification unit 12. The third acquisition unit 113 acquires third point group data PC3 from the sub camera 23. The third point group data PC3 is point group data of a subject which is acquired at a third zoom magnification by the sub camera 23. The third acquisition unit 113 provides the acquired third point group data PC3 to the identification unit 12. The fourth acquisition unit 114 acquires fourth point group data PC4 from the sub camera 24. The fourth point group data PC4 is point group data of a subject which is acquired at a fourth zoom magnification by the sub camera 24. The fourth acquisition unit 114 provides the acquired fourth point group data PC4 to the identification unit 12.

Here, it is preferable that the first to fourth zoom magnifications be the same as each other. When the zoom magnifications of the master camera 21 and the sub cameras become different with change of the zoom magnification of the master camera 21, theoretical zoom magnifications are made to be equal by performing the aforementioned coarse adjustment.

The identification unit 12 identifies an overlapping portion of the point group data acquired by the range-finding cameras installed adjacent to each other. A known algorithm may be used for identification of the overlapping portion. Information on what range-finding camera each range-finding camera is installed adjacent to may be stored in a storage unit which is not illustrated in advance. When the information on installation is not stored, the neighboring range-finding cameras may be identified using a known image processing algorithm. The identification unit 12 outputs information on the identified overlapping portion as identification information SI to the calculation unit 13.

In the illustrated example, it is assumed that the range-finding cameras are installed as illustrated in FIG. 1. That is, the master camera 21 and the sub camera 22 are adjacent to each other, the sub camera 22 and the sub camera 24 are adjacent to each other, the sub camera 24 and the sub camera 23 are adjacent to each other, and the sub camera 23 and the master camera 21 are adjacent to each other. The master camera 21 and the sub camera 24 are not adjacent to each other.

Minute adjustment of sub cameras adjacent to the master camera 21 will be first described below. The identification unit 12 identifies overlapping portions of the sub cameras adjacent to the master camera 21. In this case, the identification unit 12 identifies overlapping portions of point groups included in the first point group data PC1 acquired from the master camera 21 and point groups included in the second point group data PC2 acquired from the sub camera 22. The identification unit 12 identifies overlapping portions of point groups included in the first point group data PC1 acquired from the master camera 21 and point groups included in the fourth point group data PC4 acquired from the sub camera 24.

The calculation unit 13 calculates a reduction/enlargement magnification of the second point group data PC2 acquired from the sub camera 22 with respect to the point groups included in the first point group data PC1 acquired from the master camera 21 when the overlapping portions identified by the identification unit 12 are compared. The calculation unit 13 calculates a reduction/enlargement magnification of the third point group data PC3 acquired from the sub camera 23 with respect to the point groups included in the first point group data PC1 acquired from the master camera 21 when the overlapping portions identified by the identification unit 12 are compared. The calculation unit 13 outputs information including the calculated reduction/enlargement magnifications as calculation information CI to the determination unit 14.

The determination unit 14 determines whether the calculated reduction/enlargement magnifications are less than a predetermined threshold value. Here, the predetermined threshold value may be set in advance and stored in a storage unit which is not illustrated. The predetermined threshold value may be defined as the number of point groups which are mismatched, or it may be determined that minute adjustment is necessary, for example, when there are three or four mismatched point groups. The determination unit 14 outputs the determination result as determination information JI to the zoom magnification control unit 15.

When the determination unit 14 determines that a reduction/enlargement magnification is greater than the predetermined threshold value, the zoom magnification control unit 15 outputs a control signal for controlling a zoom position (a zoom magnification) of the corresponding sub camera. The zoom position is controlled for each sub camera. Specifically, when it is determined that the reduction/enlargement magnification of the second point group data PC2 is greater than the predetermined threshold value, the zoom magnification control unit 15 outputs a control signal ZI2 for controlling the zoom magnification of the sub camera 22 to the sub camera 22. When it is determined that the reduction/enlargement magnification of the third point group data PC3 is greater than the predetermined threshold value, the zoom magnification control unit 15 outputs a control signal ZI3 for controlling the zoom magnification of the sub camera 23 to the sub camera 23.

Minute adjustment of a sub camera not adjacent to the master camera 21 will be described below. In the illustrated example, the master camera 21 and the sub camera 24 are not adjacent to each other. On the other hand, the sub camera 24 is adjacent to the sub camera 22 and the sub camera 23 which are adjacent to the master camera 21. Therefore, in minute adjustment of the sub camera 24, reduction/enlargement magnifications with respect to the sub camera 22 and the sub camera 23 which are adjacent to the master camera 21 are calculated, and minute adjustment is performed on the basis of two reduction/enlargement magnifications. The minute adjustment of two reduction/enlargement magnifications may employ, for example, an average value of two reduction/enlargement magnifications. A statistically calculated value other than an average value, for example, a median value or a mode value, may be used for the minute adjustment based on two reduction/enlargement magnifications.

In this case, the identification unit 12 identifies overlapping portions of point groups included in the second point group data PC2 acquired from the sub camera 22 and point groups included in the fourth point group data PC4 acquired from the sub camera 24. The identification unit 12 identifies overlapping portions of point groups included in the third point group data PC3 acquired from the sub camera 23 and point groups included in the fourth point group data PC4 acquired from the sub camera 24.

The calculation unit 13 calculates a reduction/enlargement magnification of the fourth point group data PC4 acquired from the sub camera 24 with respect to the point groups included in the second point group data PC2 acquired from the sub camera 22 adjacent to the master camera 21 when the overlapping portions identified by the identification unit 12 are compared. The calculation unit 13 calculates a reduction/enlargement magnification of the fourth point group data PC4 acquired from the sub camera 24 with respect to the point groups included in the third point group data PC3 acquired from the sub camera 23 adjacent to the master camera 21 when the overlapping portions identified by the identification unit 12 are compared.

The zoom magnification control unit 15 outputs a control signal ZI4 for controlling the zoom magnification of the sub camera 24 to the sub camera 24 on the basis of the reduction/enlargement magnification of the fourth point group data PC4 with respect to the point groups included in the second point group data PC2 and the reduction/enlargement magnification of the fourth point group data PC4 with respect to the point groups included in the third point group data PC3. Specifically, the zoom magnification control unit 15 may determine the zoom magnification of the sub camera 24 on the basis of the average value of the reduction/enlargement magnification of the fourth point group data PC4 with respect to the point groups included in the second point group data PC2 and the reduction/enlargement magnification of the fourth point group data PC4 with respect to the point groups included in the third point group data PC3.

The zoom magnification control unit 15 also performs coarse adjustment of a zoom position in addition to the minute adjustment of a zoom position. When the information ZI1 on the zoom position is acquired from the master camera 21, the zoom magnification control unit 15 outputs a control signal ZI2 for controlling the zoom magnification of the sub camera 22 to the sub camera 22, outputs a control signal ZI3 for controlling the zoom magnification of the sub camera 23 to the sub camera 23, and outputs a control signal ZI4 for controlling the zoom magnification of the sub camera 24 to the sub camera 24 on the basis of the acquired information ZI1.

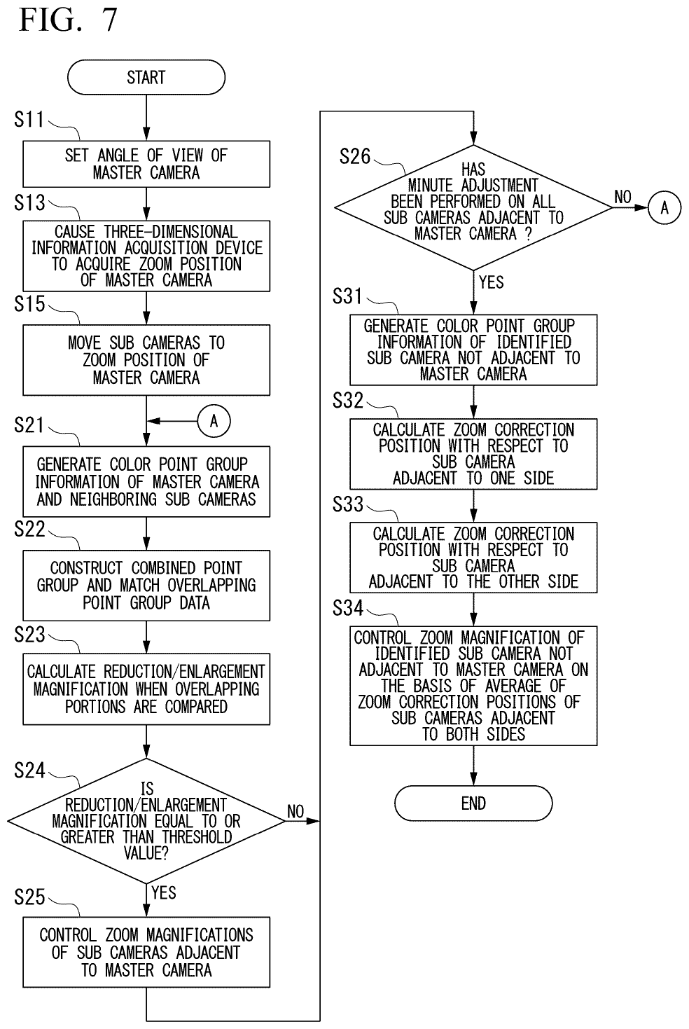

FIG. 7 is a flowchart illustrating a process flow of the three-dimensional information processing method according to the present embodiment. A process flow of the three-dimensional information processing method that is performed by the three-dimensional information processing device 10 will be described below with reference to the drawing.

(Step S11) First, matching of the angle of view of the master camera 21 is performed by an operator. The matching of the angle of view is performed by allowing an operator to directly operate the master camera 21. By performing the matching of the angle of view, the zoom position of the master camera 21 is determined.

(Step S13) Then, the three-dimensional information processing device 10 acquires information on the determined zoom position of the master camera 21. The three-dimensional information processing device 10 outputs a control signal for controlling the zoom position to the sub cameras (the sub cameras 22 to 24) on the basis of the acquired information.

(Step S15) The sub cameras (the sub cameras 22 to 24) acquire the control signal from the three-dimensional information processing device 10. Each sub camera moves to a zoom position corresponding to the acquired control signal. The processes of Steps S11 to S15 correspond to the coarse adjustment step.

(Step S21) The three-dimensional information processing device 10 generates color point group information of the master camera 21 and the sub cameras adjacent to the master camera 21. The sub cameras adjacent to the master camera 21 are specifically the sub camera 22 and the sub camera 23.

(Step S22) the three-dimensional information processing device 10 constructs combined point groups on the basis of the generated color point group information and performs matching of the overlapping point group data. Specifically, the three-dimensional information processing device 10 performs the matching by identifying overlapping portions of the point group data of the master camera 21 and the point group data of the sub camera 22. The three-dimensional information processing device 10 performs the matching by identifying overlapping portions of the point group data of the master camera 21 and the point group data of the sub camera 23.

(Step S23) The three-dimensional information processing device 10 calculates a minimum enlargement magnification when the overlapping portions are compared. Specifically, the three-dimensional information processing device 10 calculates the minimum enlargement magnification when the overlapping portions of the point group data of the master camera 21 and the point group data of the sub camera 22 are compared. The three-dimensional information processing device 10 calculates the minimum enlargement magnification when the overlapping portions of the point group data of the master camera 21 and the point group data of the sub camera 23 are compared.

(Step S24) The three-dimensional information processing device 10 determines whether the calculated reduction/enlargement magnification is equal to or greater than a predetermined threshold value. Whether the minimum enlargement magnification is equal to or greater than the predetermined threshold value may be determined by determining what the number of mismatched point groups is. Specifically, in the present embodiment, since the reduction/enlargement magnification of the sub camera 22 side and the reduction/enlargement magnification of the sub camera 23 side are calculated, the three-dimensional information processing device 10 determines whether the reduction/enlargement magnifications are equal to or greater than the predetermined threshold value. When either reduction/enlargement magnification is equal to or greater than the predetermined threshold value (that is, Step S24: YES), the three-dimensional information processing device 10 causes the process flow to proceed to Step S25. When either reduction/enlargement magnification is less than the predetermined threshold value (that is, Step S24: NO), the three-dimensional information processing device 10 causes the process flow to proceed to Step S26. (Step S25) The three-dimensional information processing device 10 controls the zoom position (zoom magnification) of a sub camera of which the reduction/enlargement magnification is equal to or greater than the predetermined threshold value.

(Step S26) When minute adjustment has been performed on all the sub cameras (specifically, the sub camera 22 and the sub camera 23) adjacent to the master camera 21, that is, when it is determined that the reduction/enlargement magnifications thereof less than the threshold value (that is, Step S26: YES), the three-dimensional information processing device 10 causes the process flow to proceed to Step S31. When minute adjustment has not been performed on all the sub cameras (specifically, the sub camera 22 and the sub camera 23) adjacent to the master camera 21, that is, when it is determined that either reduction/enlargement magnification is equal to or greater than the threshold value (that is, Step S26: NO), the three-dimensional information processing device 10 causes the process flow to return to Step S21 and repeatedly performs the minute adjustment step.

(Step S31) The three-dimensional information processing device 10 generates color point group information of a sub camera not adjacent to the master camera 21. The sub camera not adjacent to the master camera 21 is specifically, the sub camera 24.

(Step S32) The three-dimensional information processing device 10 calculates a zoom correction position with respect to the sub camera 22 which is a sub camera adjacent to one side of the sub camera 24. Specifically, the three-dimensional information processing device 10 calculates the reduction/enlargement magnification with respect to the sub camera 22 by performing the same processes as Steps S22 and S23.

(Step S33) The three-dimensional information processing device 10 calculates a zoom correction position with respect to the sub camera 23 which is a sub camera adjacent to the other side of the sub camera 24. Similarly to Step S32, the three-dimensional information processing device 10 calculates the reduction/enlargement magnification with respect to the sub camera 23 by performing the same processes as Steps S22 and S23.

(Step S34) The three-dimensional information processing device 10 controls the zoom position (zoom magnification) of a specific sub camera (that is, the sub camera 24) not adjacent to the master camera 21 on the basis of the average value of the zoom reduction/enlargement magnifications of the sub cameras (that is, the sub camera 22 and the sub camera 23) adjacent to both sides of the sub camera 24.

The processes of Steps S21 to S34 correspond to the minute adjustment step. Specifically, the processes of Steps S21 to S26 correspond to the minute adjustment step for the sub cameras adjacent to the master camera 21, and the processes of Steps S31 to S34 correspond to the minute adjustment step for the sub cameras not adjacent to the master camera 21.

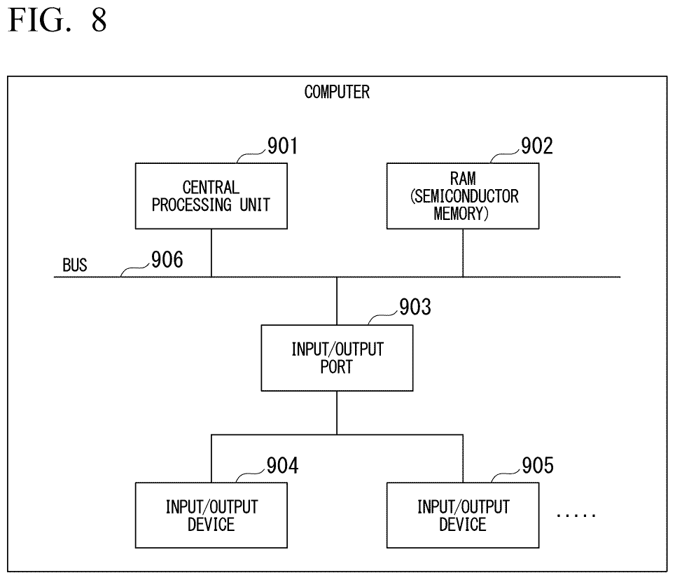

FIG. 8 is a block diagram illustrating an example of an internal configuration of the three-dimensional information processing device 10 according to the present embodiment. At least some functions of the three-dimensional information processing device 10 can be realized using a computer. As illustrated in the drawing, the computer includes a central processing unit 901, a RAM 902, an input/output port 903, an input/output device 904 or 905, and a bus 906. The computer itself can be realized using a known technique. The central processing unit 901 executes instructions included in a program read from the RAM 902 or the like. The central processing unit 901 writes data to the RAM 902, reads data from the RAM 902, or performs an arithmetic operation or a logic operation in accordance with the instructions. The RAM 902 store data or programs. Each element included in the RAM 902 has an address and can be accessed using the address. RAM is an abbreviation to “random access memory.” The input/output port 903 is a port that is used for the central processing unit 901 to exchange data with an external input/output device or the like. The input/output device 904 or 905 is an input/output device. The input/output device 904 or 905 exchanges data with the central processing unit 901 via the input/output port 903. The bus 906 is a shared communication path used in the computer. For example, the central processing unit 901 reads or writes data to or from the RAM 902 via the bus 906. For example, the central processing unit 901 accesses the input/output port via the bus 906.

### CONCLUSION OF EMBODIMENT

According to the aforementioned embodiment, the three-dimensional information processing device 10 includes the first acquisition unit 111 to acquire first point group data which is point group data of a subject acquired at a first zoom magnification by the master camera 21 (a first point group data acquisition device) and includes the second acquisition unit 112 to acquire second point group data which is point group data of the subject acquired at a second zoom magnification by the sub camera 22 (a second point group data acquisition device). Here, the angle of view at which the master camera 21 acquires the first point group data and the angle of view at which the sub camera 22 acquires the second point group data overlap each other at least partially. The three-dimensional information processing device 10 includes the identification unit 12 to identify overlapping portions of point groups included in the first point group data and point groups included in the second point group data and includes the calculation unit 13 to calculate a reduction/enlargement magnification of the second point group data with respect to the first point group data when the identified overlapping portions are compared and includes the determination unit 14 to determine whether the calculated reduction/enlargement magnification is less than a predetermined threshold value. That is, according to the three-dimensional information processing device 10, it is possible to determine whether the reduction/enlargement magnification on one side when point group data acquired by a plurality of range-finding cameras are combined is equal to or greater than the predetermined threshold value. Accordingly, according to the three-dimensional information processing device 10, it is possible to appropriately combine three-dimensional information acquired by a plurality of range-finding cameras by performing the combination when the reduction/enlargement magnification is less than the predetermined threshold value.

According to the three-dimensional information processing device 10, combination is performed using three-dimensional information instead of two-dimensional information. Accordingly, according to the present embodiment, since combination can be performed using a larger amount of information, it is possible to provide high combination accuracy.

The aforementioned three-dimensional information processing device 10 further includes the zoom magnification control unit 15 to output a control signal for controlling the zoom magnification of the sub camera when the determination unit 14 determines that the reduction/enlargement magnification is greater than the predetermined threshold value. Accordingly, according to the present embodiment, when the reduction/enlargement magnification is greater than the predetermined threshold value, it is possible to acquire point group data again by adjusting the zoom position. As a result, according to the three-dimensional information processing device 10, it is possible to acquire information of the same resolution as the master camera 21 using a sub camera and to appropriately combine three-dimensional information acquired by a plurality of range-finding cameras.

According to the aforementioned three-dimensional information processing device 10, the zoom magnification control unit 15 acquires the zoom magnification of the master camera 21 and outputs the control signal for controlling the zoom magnification of the sub camera according to the acquired zoom magnification. That is, the three-dimensional information processing device 10 performs coarse adjustment for matching the zoom magnification of the sub camera with the zoom magnification of the master camera 21 before minute adjustment is performed. According to the three-dimensional information processing device 10, it is possible to reduce a process load at the time of combination by performing coarse adjustment using an optical zoom before combining point group data. According to the three-dimensional information processing device 10, since a reduction magnification or an enlargement magnification at the time of digital combination can be limited to a small value by performing the coarse adjustment, it is possible to curb deterioration of image quality as much as possible.

The aforementioned three-dimensional information processing device 10 further includes the third acquisition unit 113 to acquire third point group data which is point group data of the subject acquired at a third zoom magnification by the sub camera 23 (a third point group data acquisition device). The angle of view at which the master camera 21 acquires the first point group data and the angle of view at which the sub camera 23 acquires the third point group data overlap each other at least partially. The three-dimensional information processing device 10 further includes the fourth acquisition unit 114 to acquire fourth point group data from the sub camera 24 (a fourth point group data acquisition device). The angle of view at which the master camera 21 acquires the first point group data and the angle of view at which the sub camera 24 acquires the fourth point group data do not overlap each other. According to the three-dimensional information processing device 10, the identification unit 12 identifies overlapping portions of point groups included in the fourth point group data and point groups included in the second point group data and identifies overlapping portions of point groups included in the fourth point group data and point groups included in the third point group data. That is, the identification unit 12 identifies overlapping portions of the sub camera adjacent to the master camera 21 and the sub camera not adjacent to the master camera 21. According to the three-dimensional information processing device 10, the calculation unit 13 calculates a reduction/enlargement magnification of the second point group data with respect to the fourth point group data and a reduction/enlargement magnification of the third point group data with respect to the fourth point group data when the identified overlapping portions are compared. The zoom magnification control unit 15 outputs a control signal for controlling the zoom magnification of the sub camera 24 not adjacent to the master camera 21 on the basis of the reduction/enlargement magnification of the second point group data with respect to the fourth point group data and the reduction/enlargement magnification of the third point group data with respect to the fourth point group data (for example, by employing an average value thereof). That is, when the zoom magnification of the sub camera 24 not adjacent to the master camera 21 is minutely adjusted, the three-dimensional information processing device 10 performs minute adjustment on the basis of the sub cameras which are adjacent to the master camera 21 and which are located on both sides of the sub camera 24 not adjacent to the master camera 21. Accordingly, according to the three-dimensional information processing device 10, even when the number of range-finding cameras is increased and there is a sub camera not adjacent to the master camera 21, it is possible to curb accumulation of an error and generation of unbalanced three-dimensional information.

All or some of the functions of the constituent units of the three-dimensional information acquisition system 1 according to the embodiment may be realized by recording programs for realizing the functions on a computer-readable recording medium and causing a computer system to read and execute the programs recorded on the recording medium. The “computer system” mentioned herein includes an OS or hardware such as peripherals.

The “computer-readable recording medium” is a portable medium such as a flexible disk, a magneto-optical disc, a ROM, or a CD-ROM or a storage unit such as a hard disk incorporated into a computer system. The “computer-readable recording medium” may also include a medium that dynamically hold a program for a short time such as a communication line when the program is transmitted via a network such as the Internet or a communication line such as a telephone line or a medium that holds a program for a predetermined time such as a volatile memory in a computer system serving as a server or a client in that case. The program may be a program for realizing some of the aforementioned functions or may be a program for realizing the aforementioned functions in combination with another program stored in advance in the computer system.

While an embodiment of the present invention have been described above, the present invention is not limited to the embodiment, and various modifications may be added thereto without departing from the gist of the present invention. The aforementioned embodiments may be appropriately combined.

### INDUSTRIAL APPLICABILITY

According to the present invention, it is possible to appropriately combine three-dimensional information acquired using a plurality of range-finding cameras.

### REFERENCE SIGNS LIST

1 Three-dimensional information acquisition system
10 Three-dimensional information processing device
21 Master camera
22 Sub camera
23 Sub camera
24 Sub camera
111 First acquisition unit
112 Second acquisition unit
113 Third acquisition unit
114 Fourth acquisition unit
12 Identification unit
13 Calculation unit
14 Determination unit
15 Zoom magnification control unit

What is claimed is:

1. A three-dimensional information processing device comprising:
a first acquisition unit configured to acquire first point group data which is point group data of a subject acquired at a first zoom magnification by a first point group data acquisition device;
a second acquisition unit configured to acquire second point group data which is point group data of the subject acquired at a second zoom magnification by a second point group data acquisition device, the second point group data acquisition device acquiring point group data at an angle of view of which at least a part overlaps an angle of view at which the first point group data acquisition device acquires the first point group data;
an identification unit configured to identify overlapping portions of point groups included in the first point group data and point groups included in the second point group data;
a calculation unit configured to calculate a reduction/enlargement magnification of the second point group data with respect to the first point group data when the identified overlapping portions are compared; and
a determination unit configured to determine whether the calculated reduction/enlargement magnification is less than a predetermined threshold value.

2. The three-dimensional information processing device according to claim 1, further comprising a zoom magnification control unit configured to output a control signal for controlling the zoom magnification of the second point group data acquisition device when the determination unit determines that the calculated reduction/enlargement magnification is greater than the predetermined threshold value.

3. The three-dimensional information processing device according to claim 2, wherein the zoom magnification control unit acquires the zoom magnification of the first point group data acquisition device acquiring the first point group data and outputs the control signal for controlling the zoom magnification of the second point group data acquisition device according to the acquired zoom magnification.

4. The three-dimensional information processing device according to claim 2, further comprising:
a third acquisition unit configured to acquire third point group data which is point group data of the subject acquired at a third zoom magnification by a third point group data acquisition device, the third point group data acquisition device acquiring point group data at an angle of view of which at least a part overlaps an angle of view at which the first point group data acquisition device acquires the first point group data; and
a fourth acquisition unit configured to acquire fourth point group data from a fourth point group data acquisition device, the fourth point group data acquisition device acquiring point group data at an angle of view not overlapping an angle of view at which the first point group data acquisition device acquires the first point group data,
wherein the identification unit identifies overlapping portions of point groups included in the fourth point group data and point groups included in the second point group data and identifies overlapping portions of point groups included in the fourth point group data and point groups included in the third point group data,
wherein the calculation unit calculates a reduction/enlargement magnification of the second point group data with respect to the fourth point group data when the identified overlapping portions are compared and a reduction/enlargement magnification of the third point group data with respect to the fourth point group data when the identified overlapping portions are compared, and
wherein the zoom magnification control unit outputs a control signal for controlling a zoom magnification of the fourth point group data acquisition device on the basis of the reduction/enlargement magnification of the second point group data with respect to the fourth point group data and the reduction/enlargement magnification of the third point group data with respect to the fourth point group data.

5. A three-dimensional information processing method comprising:
a first acquisition step of acquiring first point group data which is point group data of a subject acquired at a first zoom magnification by a first point group data acquisition device;
a second acquisition step of acquiring second point group data which is point group data of the subject acquired at a second zoom magnification by a second point group data acquisition device;
an identification step of identifying overlapping portions of point groups included in the first point group data and point groups included in the second point group data;
a calculation step of calculating a reduction/enlargement magnification of the second point group data with respect to the first point group data when the identified overlapping portions are compared; and
a determination step of determining whether the calculated reduction/enlargement magnification is less than a predetermined threshold value.
